(19) United States
(12) Patent Application Publication
(10) Pub. No.: US 2013/0149665 A1
(43) Pub. Date: Jun. 13, 2013

(54) DENTAL WEDGE WITH COATNG

(71) Applicant: William B. DRAGAN, Easton, CT (US)

(72) Inventor: William B. DRAGAN, Easton, CT (US)

(21) Appl. No.: 13/323,739

(22) Filed: Dec. 12, 2011

(51) Int. Cl. A61C 5/12; B05D 3/02

(52) U.S. Cl. 433/149; 427/2.14

(57) ABSTRACT

A non-porous dental wedge having a surface coating of a material for aiding a dental procedure. A thin coating of an adhesive and particles having a particle size less than 200 microns is placed on the surface of the non-porous dental wedge. The material is preferable an astringent. The non-porous dental wedge is resistant to compression and the thin surface coating with small material particle size facilitates rapidly disperses the material during a dental procedure.

### FIELD OF THE INVENTION

The present invention relates in general to a dental wedge, and more particularly to a dental wedge having a surface coating for rapidly delivering a material during a dental procedure.

### BACKGROUND OF THE INVENTION

In many dental procedures, dental wedges are often needed. In some dental procedures, tooth material must often be removed between two teeth. In restoring the tooth, a matrix band is often placed between the two teeth to form a wall so as to contain a restorative dental material. During these dental procedures the tissue is sometimes injured and may cause bleeding or oozing of fluids. In order to obtain a good fit between the matrix band and the tooth, a dental wedge is often forced into the area between the matrix band and an adjacent tooth. The matrix band is thereby forced against the tooth being restored. A poor matrix band fit may result in a permanent irritation and possible periodontal abscess. The dental wedge is also often helpful in forcing the teeth apart, allowing for the thickness of the matrix band to be placed between the teeth. Typically, dental wedges are relatively small pieces of material, made of wood or plastic, that come in a variety of different shapes. Generally, wood dental wedges have more limited shapes due to the difficulty in manufacturing the more complicated shapes. Dental wedges in most applications are placed in position by grasping the end with a pair of small plies or forceps. However, some dental wedges may have a handle attached to facilitate placement.

One such dental wedge is disclosed in U.S. Pat. No. 6,482,007 entitled “Dental Wedge with Handle” and issuing to Stanwich et al on Nov. 19, 2002. Therein disclosed is a dental wedge having a frangible handle portion that facilitates easy handling of the small dental wedge. Another dental wedge is disclosed in U.S. Pat. No. 6,929,475 entitled “Pre-dosed Applicator and Applicator System” and issuing to Dragan on Aug. 16, 2005. Therein disclosed is a flocked wedge that is pre-dosed with an astringent or hemostatic agent. Another dental wedge is disclosed in U.S. Pat. No. 4,468,199 entitled “Dental Wedge” and issuing to Weikel on Aug. 28, 1984. Therein disclosed is a dental wedge made of a porous material, such as wood, that is impregnated with a hemostatic agent. The crushing force to which the porous material of the wedge is subjected forces the hemostatic material from the wedge as it is inserted.

While these dental wedges have been helpful in various dental procedures, they are sometimes difficult to work with and do not consistently achieve there desired results well. In some situations, when flocking is applied to the dental wedge, the flocking may sheer off when inserted into position between teeth or otherwise be somewhat compressible, making accurate and tight placement of a dental wedge difficult. Similarly, when a dental wedge is made of a porous or compressible material, such as wood, the dental wedging action may not be as accurate and effective as desired. Additionally, when a hemostatic agent is impregnated into the porous material, its delivery may be delayed and therefore may not have a sufficiently quick response in controlling bleeding during the dental procedure, which may occur over a relatively short time. Dental wedges often come in different shapes. These different shapes are often difficult to make in wood. Therefore, the use of wood may restrict the different shapes of dental wedges desired.

Accordingly, there is a need for a dental wedge that can be securely placed and provides improved wedging action with more rapid delivery of a material, and in particular an astringent or hemostatic agent for controlling bleeding.

### SUMMARY OF THE INVENTION

The present invention comprises a dental wedge that is substantially non-porous and non-compressible, having a thin surface coating of a material that is to be delivered when the dental wedge is placed in position during a dental procedure. A material, such as an astringent or hemostatic agent, is affixed to the surface of the dental wedge with a thin surface coating. A fine, granular or particles of material may be mixed with an epoxy adhesive providing a suspension that may be thinly coated on the dental wedge. The particles of material are preferably less than 200 microns.

Accordingly it is an object of the present invention to provide a better performing dental wedge.

It is an advantage of the present invention that material is quickly delivered during the dental procedure.

It is a feature of the present invention that a coating of particle of material is adhesively affixed to the surface of the dental wedge.

These and other objects, advantages, and features will become more readily apparent in view of the following more detailed description.

### BRIEF DESCRIPTION OF THE DRAWINGS

FIG. 1 is a perspective view illustration an embodiment of the present invention.

FIG. 2A is a side elevational view of a dental wedge of the embodiment illustrated in FIG. 1.

FIG. 2B is a cross section taken along line 2B-2B in FIG. 2A.

FIG. 3 schematically illustrates placement of a dental wedge between two teeth.

FIG. 4A is a side elevational view of a shaped dental wedge embodiment of the present invention.

FIG. 4B is a front elevational view of the shaped dental wedge embodiment illustrated in FIG. 4A.

### DETAILED DESCRIPTION OF THE PREFERRED EMBODIMENT

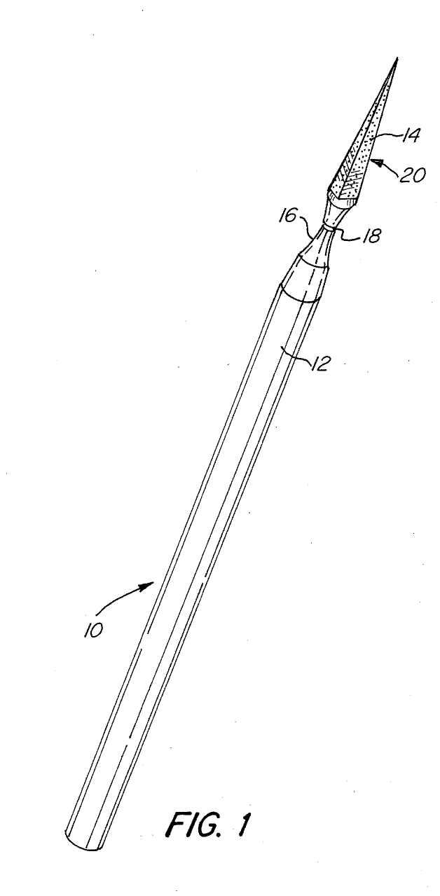

FIG. 1 illustrates an embodiment of the present invention that facilitates placement of the dental wedge. FIG. 1 illustrates a dental wedge with a frangible handle 10. In this embodiment, a handle 12 is attached to the dental wedge 14 by frangible portion 18 having a neck 16. The dental wedge 14 has a thin coating 20 on the surface.

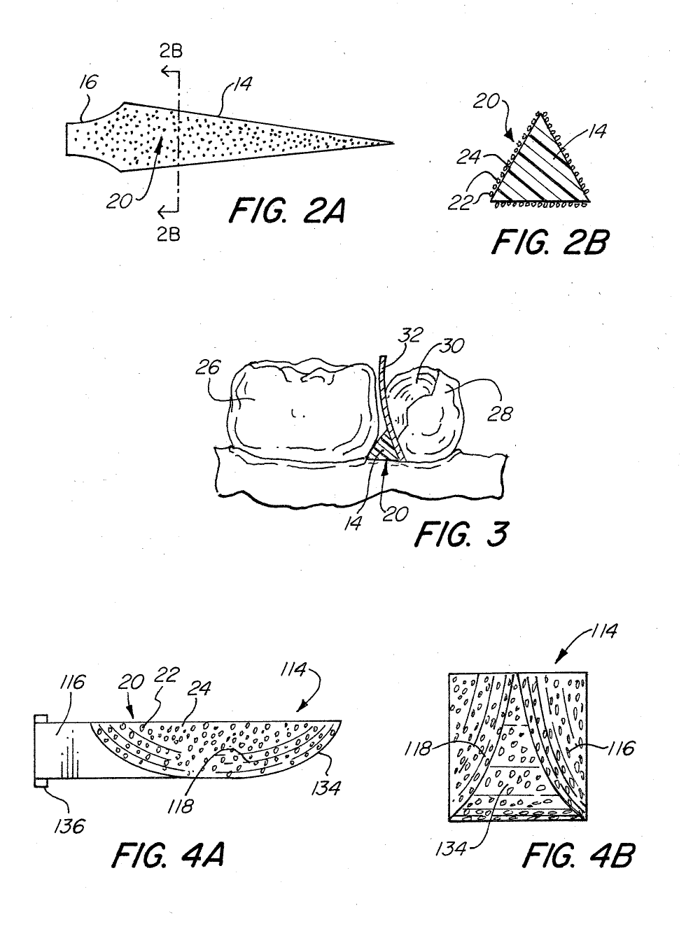

FIGS. 2A and 2B more clearly illustrate the surface coating 20 placed on the dental wedge 14. FIG. 2B is a cross section of the dental wedge 14 taken along line 2B-2B in FIG. 2A. The dental wedge 14 is preferably made of an incompressible, non-porous material, such as a plastic. A thin coating 20 is applied to the surfaces of the dental wedge 14. In this embodiment, the cross section of the dental wedge 14 forms a triangle. On each side surface of the triangle, a surface coating is applied comprising particles 22 with an adhesive 24. This relatively thin surface coating 20 facilitates the rapid dispensing or application of the material from which the particles 22 are formed. The particles preferably have a diameter or lateral dimension of less than two-hundred microns. It has been discovered that this particle size of less than two-hundred microns performs surprisingly well and permits easy insertion of the dental wedge between teeth and provides rapid or quick dispensing of the material greatly facilitating the dental procedure. In particular, during testing with particles of an astringent material the invention controlled bleeding or oozing of the gums much better than existing dental wedges, and especially in sub-gingival preparations. The dental wedge helps to hold the matrix band adjacent the gingival seat or base helping to prevent leaking or forcing of material into the gingival tissue which may cause gingival problems.

FIG. 3 illustrates the application of the present invention and the placement of the dental wedge 14 between a tooth 26 and a prepared tooth 28. The prepared tooth 28 has a prepared cavity 30. Between the tooth 26 and the prepared tooth 28 is placed a matrix band 32. The dental wedge 14 is positioned so as to wedges the matrix band 32 adjacent the base of the prepared tooth 28. The dental wedge 14 being substantially non-porous and substantially non-compressible or incompressible assures that the surface coating placed thereon is rapidly dispensed and that the matrix band 32 is securely wedged adjacent the prepared tooth 28 providing a good restoration.

FIGS. 4A and 4B illustrate another embodiment of the present invention utilizing a shaped dental wedge 114. In this embodiment an elongated handle is not attached to the shaped dental wedge 114. The dental wedge in this embodiment may be placed in position with pliers or forceps. The shaped dental wedge 114 has concave faces 118 and a rectilinear rear portion 116 having a gripping shoulder 136 placed thereon. The gripping shoulder 136 facilitates the holding, positioning, and removal of the shaped dental wedge 114. Curved front 134 facilitates insertion between teeth. The surfaces of the shaped dental wedge 114 have a coating 20 thereon. The coating 20 comprises particles of material 22 and adhesive 24. The dental wedge 114 is made of a non-porous, non-compressible material, such as plastic.

The coating 20 placed on the dental wedges 14 and 114 is preferably provided as a thin surface coating. The use of a thin surface coating and particle size makes it easier to place the wedge in tight locations between teeth and permits the rapid dispensing of the material. This is an improvement over the dental wedges having a flock coating or that are impregnated with a material. The present invention may be placed within tight spaces without the problem of sheering the flock coating, as in prior devices. The sheering of the flocked coating created potential problems of contamination and compromising the dental restoration. Additionally, the relatively thin surface coating and small particle size permits the material to be dispensed and absorbed quickly. The small particle size permits the material to go into solution quickly. The surface coating permits much quicker delivery than porous dental wedges that have been impregnated. The surface coating does not require the time required for the impregnated material to leech from the porous dental wedge.

The coating 20 may be placed on the dental wedge 14 and 114 by any convenient means. One successful method of applying the coating 20 is by using a very thin, non-viscous glue or adhesive, such as an epoxy, and dipping the dental wedge therein. Excess glue may be removed with a gentle air stream that may also aid in evaporating any thinning solvent or agent, leaving a very thin glue coating on the dental wedge. A material, such as an astringent, may then be sprinkled onto the glue or adhesive coating the dental wedge. The material should take the form of a fine particle or powder, preferably having a size less than two-hundred microns. Any excess particle of material may be shaken off or brushed lightly, assuring a thin coating. The dental wedges may be then permitted to dry or the adhesive cured. To expedite the drying the coated dental wedges may be placed in a drying oven. While the preferred material is an astringent, such as alum, aluminum sulfate, aluminum chloride or ferric sulfate, the material may be other types of materials that are desired to be dispensed quickly in a dental procedure. Such other materials may be a therapeutic agent or medicament such as an antibacterial agent, for example tetracycline, or any other medicament for periodontal delivery for the treatment of any possible disease. The material may also be a flavoring agent.

An alternate method of applying the thin surface coating 20 to the dental wedges 14 and 114 may be by creating a suspension of a very thin or non-viscous liquid adhesive, epoxy, or glue with a fine particulate material mixed therein. The adhesive, epoxy, or glue may be thinned with a suitable thinner, such as acetone or xylene. The dental wedge may then be dipped into this suspension, providing a thin coating of adhesive mixed with particles of the material. To improve adhesion of the coating 20, the surface of the dental wedge 14 and 114 may be treated, for example with a plasma treatment, so as to provide a slightly roughened surface or a surface that will increase the adhesion of the particles in the surface coating 20.

While the present invention has been described with respect to several different embodiments, it will be obvious that various modifications may be made without departing from the spirit and scope of this invention.

1. A dental wedge for insertion between teeth and used in a dental procedure comprising:
a dental wedge, said dental wedge being made of a non-porous material having three side surfaces forming a triangle;
a roughened surface formed on each of the three side surfaces; and
a coating placed on the roughened surface on each of the three side surfaces of said dental wedge, said coating comprising an adhesive and particles of a material,
whereby when said dental wedge is placed in position between teeth the material is rapidly dispersed.

2. A dental wedge for insertion between teeth and used in a dental procedure as in claim 1 wherein:
the particles have a size less than two-hundred microns.

3. A dental wedge for insertion between teeth and used in a dental procedure as in claim 1 wherein:
the non-porous material comprises plastic.

4. A dental wedge for insertion between teeth and used in a dental procedure as in claim 1 wherein:
the material comprises an astringent.

5. A dental wedge for insertion between teeth and used in a dental procedure as in claim 4 wherein:
the astringent is selected from the group consisting of alum, aluminum sulfate, aluminum chloride, and ferric sulfate.

6. A dental wedge for insertion between teeth and used in a dental procedure as in claim 1 wherein:
the material comprises a therapeutic agent.

7. A dental wedge for insertion between teeth and used in a dental procedure as in claim 6 wherein:
the therapeutic agent comprises an antibacterial agent.

8. A dental wedge for insertion between teeth and used in a dental procedure comprising:
a dental wedge, said dental wedge being made of a substantially non-porous non-compressible plastic material having three side surfaces forming a triangle;
a roughened surface formed on each of the three side surfaces;
an adhesive placed on at least a portion of the three side surfaces;
particles of an astringent material having a size of less than two-hundred microns adhered to the three side surfaces by said adhesive forming a surface coating; and
whereby when said dental wedge is placed in position between teeth the astringent material in the surface coating is rapidly dispersed.

9. A dental wedge for insertion between teeth and used in a dental procedure as in claim 8 wherein:
the astringent is selected from the group consisting of alum, aluminum sulfate, aluminum chloride, and ferric sulfate.

10-16. (canceled)

17. A dental wedge for insertion between teeth and dispensing an astringent used in a dental procedure comprising:
a dental wedge, said dental wedge being made of a non-porous material having three side surfaces forming a triangle;
a roughened surface formed on each of the three side surfaces; and
an astringent coating placed on the roughened surface on each of the three side surfaces of said dental wedge, said astringent coating comprising an adhesive and aluminum sulfate,
whereby when said dental wedge is placed in position between teeth the aluminum sulfate is rapidly dispersed.

18. A dental wedge as in claim 1 wherein:
the roughened surface is formed by a plasma treatment.

19. A dental wedge as in claim 1 wherein:
the three side surfaces are planar.

20. A dental wedge as in claim 1 wherein:
at least two of the three side surfaces have concave faces.

21. A dental wedge as in claim 1 wherein:
the particles of material comprise aluminum sulfate.
